(19) United States
(12) Patent Application Publication
(10) Pub. No.: US 2010/0227290 A1
(43) Pub. Date: Sep. 9, 2010

(54) ORTHODONTIC DEVICE

(76) Inventor: Yoav Hameiri, Rehovot (IL)

Correspondence Address: MARK TRITEL, 616 CORPORATE WAY, SUITE 2 #3771, VALLEY COTTAGE, NY, 10989-2050, US

(21) Appl. No.: 12/399,953

(22) Filed: Mar. 8, 2009

(51) Int. Cl. A61C 7/00

(52) U.S. Cl. 433/23

(57) ABSTRACT

An orthodontic device comprising an elongated flexible band for wrapping around a tooth. The band comprises an inner surface for contacting the tooth and an outer surface having a wire holding mechanism affixed thereto. The device further comprises a locking mechanism comprising a slot located at a first end of the band and a series of stopper elements protruding from the outer surface of the band. A second end of the band and at least a portion of the stopper elements are insertable through the slot for tightening the band around the tooth. The band further comprises a marking for indicating a preferred location for separating the portions of the band comprising the locking mechanism components from the portion of the band comprising the wire holding mechanism. Each marking is situated on one of each sides of the wire holding mechanism.

### FIELD OF INVENTION

The present invention relates to the field of dentistry. In particular, the present invention relates to orthodontics. More particularly, the present invention relates to a device for improving the procedure of applying braces to teeth.

### BACKGROUND OF INVENTION

Orthodontic braces (or simply, braces) are used to correct misalignments of teeth. Typically, brackets are affixed to the buccal side of at least some of the teeth of one or both of the upper arch (maxilla) and the lower arch (mandible). One or more wires (archwires) join the brackets and apply a pulling force to the misaligned teeth to correct the irregularities in their positions. Due to the unaesthetic appearance of the brackets and wire which are seen protruding from the teeth every time the mouth is opened, in some cases, the brackets are affixed to the lingual side of the teeth to keep the braces hidden from the outside view.

In order to affix a bracket to a tooth, a portion of the tooth is first engraved with an etching agent to create a suitable flat and indented surface for receiving the bracket. A bonding material is applied to the tooth and the bracket is stuck thereto. The bracket is held in place and the bonding material is cured. This procedure is performed for each tooth requiring a bracket to be affixed thereto. Archwire is then pulled through each bracket to force the teeth into the desired position.

During the entire time in which the braces are positioned within the mouth, the person must restrict the types of food he eats so as not to cause the brackets to break off as a result of chewing hard foods. Additionally, during the bracket mounting process, the force applied when pulling the archwire to connect the brackets often results in the brackets being pulled off the teeth. This occurrence is particularly prevalent when the brackets are mounted on the lingual side of the teeth. Moreover, in cases of especially severe malocclusions and deep bites, blocking devices must be placed in the mouth to prevent the jaws from performing a complete bite, which would potentially cause the brackets to break off from the teeth.

It is important for the area surrounding the tooth being worked on to remain dry so as not to affect the adhesiveness of the bonding material. It is particularly difficult to attain dryness during this procedure when attaching brackets to the lingual surfaces, and especially to the molar and premolar teeth due to the accumulation of saliva at the back of the mouth. Hence, it is common for orthodontists to utilize a metal band (or, ring) that has a bracket permanently affixed thereto, to place around the tooth in the difficult area. The orthodontist much choose from a supply of typically 30 different sized bands in order to find a band that has a suitable diameter and morphological structure to position around the desired tooth.

The process of determining the appropriate band considerably lengthens the time it takes to complete the braces fitting procedure. The orthodontist uses trial and error by positioning and removing bands until the appropriate band is found. Each band is placed by utilizing a dental tool known as a “pusher”, which often slips off the band and cuts the gingiva, causing bleeding to occur. Additionally, the metal bands themselves often dig underneath the gingiva. This can allow food particles and debris to become lodged at the base of the tooth, underneath the gingiva, and can lead to inflammation of the gingival tissue, and eventually to other dental problems.

The ability to perform and complete the procedure is dependent on the orthodontist's supply of bands. Even if only one of the 30 bands is missing from the inventory, may require the procedure to be pushed off to a later date.

When bands are required to be positioned around a tooth that is covered by a temporary or permanent crown, the pressure applied when fitting the band around the tooth often causes the crown to become dislocated, and fall off the tooth.

Furthermore, when it is desired to insert band-mounted brackets in the mouth, flexible separators are positioned interproximally for a period of typically 48 hours prior to the procedure in order to form a space between adjacent teeth to allow the orthodontist to place the band around the desired tooth without being obstructed by contacting teeth. This period is typically uncomfortable for the patient and requires an additional visit to the orthodontist to place the separators in the mouth.

There exist several prior art devices that may be used to overcome at least some of the drawbacks associated with placing braces within a mouth, as described herein above. However, all of these devices are associated with difficulties and problems of their own. Relevant prior art orthodontic devices include the following.

U.S. Pat. No. 4,553,937, to Ropers, discloses a matrix band to encircle a tooth to define the wall of a cavity to be supplied with a filling. A toothed tongue of reduced width on one end portion can be fitted in the slot in the tab formed by the other reduced width end portion to enable the band to be drawn tightly around the tooth.

U.S. Pat. No. 4,840,562, to Wilson et al., discloses an adjustable orthodontic band incorporating a soft metal ribbon and mechanism for independently stretching the upper and lower halves of the ribbon so as to better conform to the anatomical shape of the tooth.

U.S. Pat. No. 5,382,160, to Shemet, discloses a dental matrix for used in a dental procedure, having a wide flat central portion and at least one outwardly extending arm having ratchet-like teeth. The central portion has a slot cut therein so as to accommodate the ratchet portion, in order to tighten the matrix around the tooth.

U.S. Pat. No. 5,697,783, to Wilson et al., discloses an adjustable orthodontic band formed of a strip of a relatively soft material such as annealed metal or flexible plastic. One end of the band has tabs formed into a shackle and flexible projections. The other end of the band has a tang containing rectangular openings for accommodating the projections, for tightening the band around the tooth.

U.S. Pat. No. 6,059,568, to Munro et al., discloses an orthodontic band for placement on a molar tooth, including a strip of flexible material, having locking means adjacent to each end of the band. The band is fit over a tooth and tightened and an orthodontic cement is placed between the band and the tooth.

Other relevant patent documents include U.S. Pat. No. 2,378,279 and U.S. Pat. No. 5,257,439.

It is therefore an object of the present invention to provide an orthodontic device for placing braces within a mouth, which overcomes the difficulties and drawbacks associated with prior art methods and devices for placing braces within the mouth, as described herein above.

It is an additional object of the present invention to provide an orthodontic device that maintains an aesthetically appealing look.

It is yet an additional object of the present invention to provide an orthodontic device that is not dependent on a large amount of inventory in order to perform a braces placing procedure.

It is still another object of the present invention to provide an orthodontic device that does not require any pretreatment preparation.

It is a further object of the present invention to provide an orthodontic device that minimizes the amount of bleeding within the mouth.

It is still a further object of the present invention to provide an orthodontic device that minimizes the potential of brackets being broken off from teeth.

It is yet a further object of the present invention to provide an orthodontic device that is inexpensive to manufacture, and requires little skill to operate.

Additional objects and advantages of the present invention are described in detail herein below.

### SUMMARY OF INVENTION

The present invention relates to an orthodontic device comprising an elongated flexible band for wrapping around a tooth, wherein said band comprises an inner surface for contacting said tooth and an outer surface having a wire holding mechanism affixed thereto, wherein said wire holding mechanism is positioned at a predetermined location along said band, and wherein said device further comprises a locking mechanism comprising a slot located at a first end of said band and a series of stopper elements protruding from said outer surface of said band, wherein a second end of said band and at least a portion of said stopper elements are insertable through said slot for tightening said band around said tooth, and wherein said band further comprises a marking for indicating a preferred location for separating the portions of said band comprising said locking mechanism components from the portion of said band comprising said wire holding mechanism, wherein each marking is situated on one of each sides of said wire holding mechanism.

The marking indicates a portion of the band between opposing transversal edges of said band. Preferably, the marking comprises a plurality of apertures, such as perforations, in the band. The marking is preferably cuttable by a sharp object such as a blade or dental drill.

The stopper elements protruding from the outer surface of the band are teeth designed to enable said band to be inserted through the slot, and to prevent said band from sliding out of said slot. The teeth preferably comprise a front face for inserting through the slot, and a back face designed to prevent said band from sliding out of said slot. The front face preferably comprises any one of a rounded curvature and an inclined curvature with respect to the outer surface of the band. The back face comprises any one of a rounded curvature and an orthogonal orientation with respect to the outer surface of the band.

Optionally, the wire holding mechanism comprises a conventional orthodontic bracket. Alternatively, the wire holding mechanism comprises a tube mounting orthodontic bracket.

In one embodiment, the portion of the band comprising the series of stopper elements is bifurcated into two branches for enabling adjusting said band around the tooth according to the curvature of said tooth. In this embodiment, the slot comprises two independent openings, each of which for receiving one of each branch.

In one aspect, the wire holding mechanism is located near the slot such that when the band is wrapped around the tooth, said wire holding mechanism and said slot are situated at the same side of said tooth.

In another aspect, the wire holding mechanism is positioned distant from the slot such that when said band is wrapped around the tooth, said wire holding mechanism and said slot are situated at opposite sides of said tooth.

In one aspect, the band comprises an arm extending therefrom at one end, for affixing to an adjacent tooth. Alternatively, the band comprises a knob element protruding therefrom, for enabling tooth rotation. Alternatively, the band comprises a hook element for mounting rubber bands thereon.

Preferably, the device further comprises a cover for enclosing the portion of the elements within the mouth.

Preferably, the slot comprises a flap for preventing the band from sliding out of said slot in the direction from which it was inserted. Preferably, the flap is repositionable to allow the band to slide out of the slot in the direction from which it was inserted.

Preferably, the inner surface of the band comprises a rough texture for increasing retention around the tooth.

### BRIEF DESCRIPTION OF THE FIGURES

In the drawings:

FIG. 1 shows a perspective view of a preferred embodiment of the device of the present invention;

FIG. 2 shows the device of FIG. 1, positioned around a tooth;

FIG. 3 shows a perspective view of an alternative aspect of the preferred embodiment of the present invention;

FIG. 4 shows the device of FIG. 3, positioned around a tooth;

FIG. 5 shows alternative embodiments of the stopper elements of the present invention;

FIGS. 6a and 6b show the end tab of the slot of the present invention for enabling readjusting of the band around the tooth in the working position (FIG. 6a) and in the adjusting position (FIG. 6b);

FIGS. 7a and 7b show alternative embodiments of the apertures of the marking of the present invention, in a cross-sectional longitudinal view;

FIG. 8 shows an embodiment of the present invention having a mechanism for enabling rotation of the tooth;

FIG. 9 shows an embodiment of the present invention having a mechanism for mounting internal rubber bands thereon;

FIG. 10 shows an embodiment of the present invention wherein the wire holding mechanism comprises a mechanism for mounting tubes thereon and for securing headgear thereto;

FIG. 11 shows an embodiment of the present invention for securing the device positioned around a tooth to an adjacent tooth;

FIG. 12 shows a second embodiment of the device of the present invention having a band with bifurcated branches; and,

FIG. 13 shows the second embodiment of the device positioned around a canine tooth.

### DETAILED DESCRIPTION OF THE PREFERRED EMBODIMENTS

The procedure of placing braces within the mouth is associated with various difficulties, both for the patient as well as the orthodontic practitioner. The length of time that the procedure takes, as well as the bleeding that is often caused, is uncomfortable and painful to the patient. For the orthodontist, dependency on a stock of correctly sized bracket bands and trial and error, leads to a lengthy procedure time, and reduces the number of patients he can see per day. In light of these, among other problems, the present invention provides an orthodontic device that increases the time efficiency as well as reduces the discomfort involved with the procedure. The device is a flexible band having a wire holding mechanism attached thereto, which is positioned around a desired tooth, and which allows for adjusting to a suitable diameter in order to fit around the tooth.

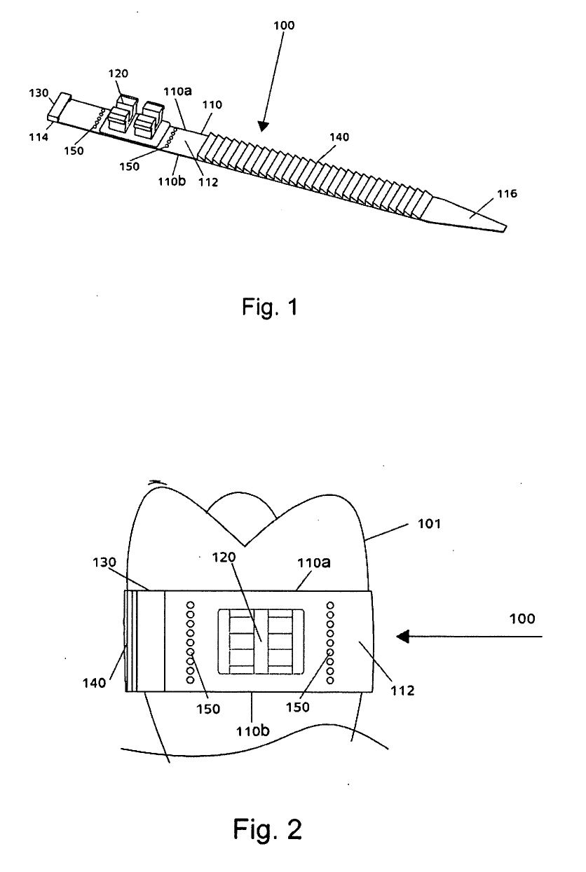

A preferred embodiment of the orthodontic device of the present invention is shown in FIG. 1 in a perspective view, and designated generally by reference numeral (100). Device (100) comprises an elongated flexible band (110) having an inner surface (not shown in this figure) in contact with the external surface of a tooth when wrapped around the tooth (101) (see FIG. 2), and an outer surface (112) having a wire holding mechanism (120), shown in this embodiment as a conventional braces bracket, affixed thereto and positioned at a predetermined location along band (110). Device (100) also has a locking (or, restraining) mechanism, comprising a slot (130), located at a first end (114) of band (110), and a series of protruding stopper elements (140) (or, one-way teeth), extending from outer surface (112) of band (110), and located preferably near a second end (116) of band (110). A marking (150) for indicating a preferred location for separating the portions of band (110) that have the components of the locking mechanism (i.e. slot (130) and protruding stopper elements (140)) from the portion of band (110) that has wire holding mechanism (120), is situated on one of each sides of wire holding mechanism (120), and described in greater detail herein below.

Band (110) is preferably manufactured from a single piece of flexible material such as plastic, silicon, etc. and is preferably transparent for aesthetic purposes, as described herein below. Wire holding mechanism (120) is preferably comprised of a rigid material, such as metal, rigid plastic, etc., and may be manufactured integrally with band (110) or permanently affixed thereto. Alternatively, band (110) comprises an aperture through which holding mechanism (120) is inserted such that the back face of holding mechanism (120) is in direct contact with the tooth when band (110) is wrapped around the tooth.

With reference to FIG. 1, for convenience purposes, second end (116) is the lead end for inserting device (100) into the mouth, such that slot (130) is maintained mesially. This allows the orthodontist to close and tighten band (110) without having to reach further into the patient's mouth than necessary. It is understood that when contemporary brackets (which are designed having angled hooks for receiving the wire, depending on the tooth on which it is meant to be placed) are utilized with the device, the device is manufactured with this directional insertion in mind. Alternatively, the bracket hooks may be oriented at 90 degree angles, as shown, in which case the brackets are essentially, “universal”.

In order to position a prior art band around a tooth, a preparatory period is typically required in order to create a space between the desired tooth and those flanked on either side of it, to enable the band to fit around the tooth. In the present invention, a preparatory period is generally not required since the flexibility of the band allows for sliding and maneuvering around a tooth that has little or no space between it and the adjacent teeth flanked on either side.

As seen in FIG. 2, and as described further herein below, when in use, band (110) is positioned (or, wrapped) around a tooth (101), preferably such that wire holding mechanism (120) is positioned either on the buccal side or lingual side of tooth (101). With reference to the embodiment shown in FIG. 1 and FIG. 2, slot (130) is situated close to wire holding mechanism (120) such that when band (110) is positioned around a tooth (101), slot (130) is essentially on the same buccal or lingual side of tooth (101) as that of wire holding mechanism (120).

When it is desirable for wire holding mechanism (120) to be positioned on the lingual side of the tooth, typically for aesthetic purposes, then it is also typically preferable that slot (130) is positioned lingually as well so that the buccal side of tooth (101) may appear without indications that a braces bracket is mounted on the tooth, except for the outline of transparent band (110). In this aspect, device (100) is considered a “one-size fits all” device in that it may be positioned around any molar or premolar tooth irrespective of its diameter.

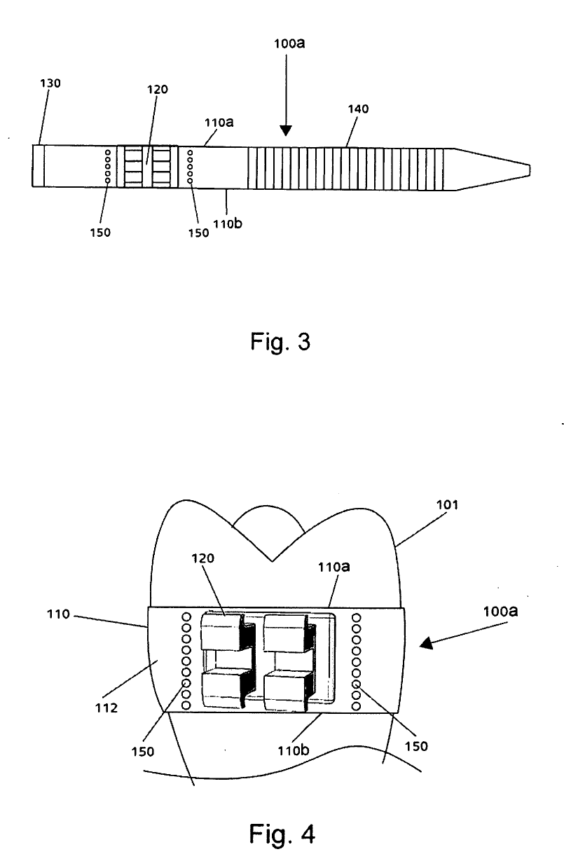

In an alternative aspect of the preferred embodiment (100a), as seen in FIG. 3 and FIG. 4, slot (130) is situated distant from wire holding mechanism (120) such that when band (110) is positioned around tooth (101), slot (130) is essentially on the opposing buccal or lingual side of tooth (101) as that of wire holding mechanism (120). In this case, more than one, preferably between 3-6 devices (100) should be kept in stock for enabling positioning around different sized molar or premolar teeth. It is understood that requiring the orthodontist to stock sets of 3-6 devices is much more efficient than requiring the orthodontist to stock sets of 30 bands of the prior art.

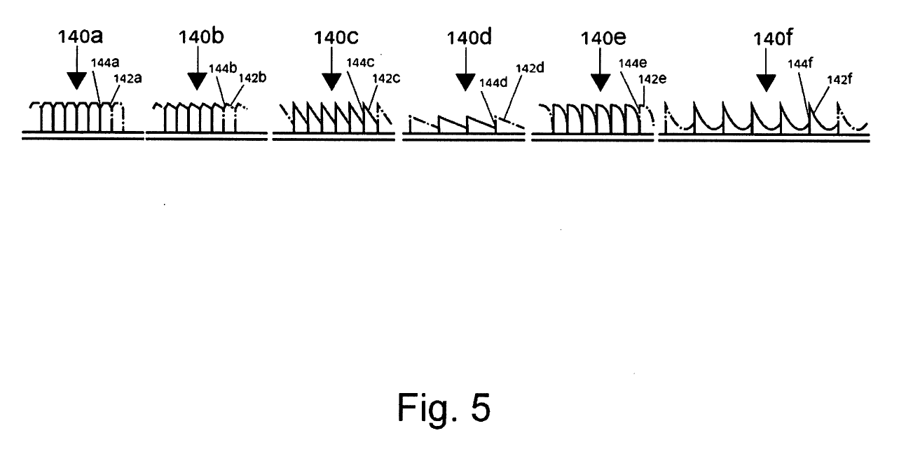

When positioning around the tooth, second end (116) of band (110) and at least a portion of stopper elements (140) are inserted through slot (130). FIG. 5 shows six embodiments (140a-f) of alternative profiles of stopper elements (wherein elements (142d) are those shown in the preferred embodiment in FIG. 1), each comprising a front face (142a-f) having an inclined or rounded curvature for inserting through slot (130), and a back face (144a-f) having essentially an orthogonal orientation with respect to outer surface (112) of band (110) for preventing band (110) from sliding out of slot (130) in the direction from which it was inserted.

Second end (116) is pulled through slot (130) in order to tighten band (110) around the tooth. When the orthodontist is satisfied that band (110) is sufficiently tight around the tooth, the portion of band (110) that extends past slot (130) is removed via a tool such as a scissors or blade, or alternatively, may be simply torn off by hand. FIG. 2, shows tightened band (110) around tooth (101) after the portion of band (110) extending past slot (130) is removed.

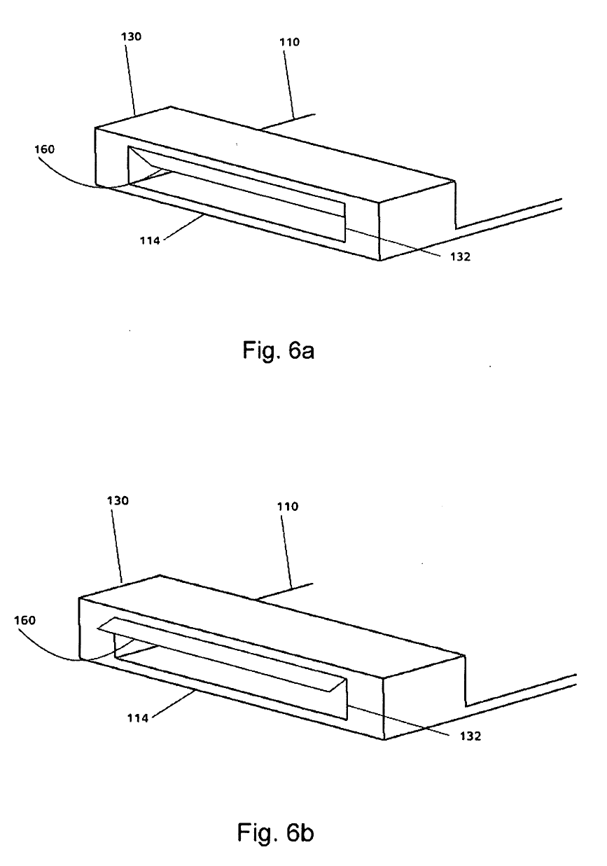

Referring to FIGS. 6a and 6b, in a case wherein the orthodontist desired to readjust (i.e. loosen) band (110), an end tab (160) positioned in slot (130) at first end (114) of band (110) may be lifted to allow band (110) to slide out of slot (130) in the direction from which it was inserted. FIG. 6a shows end tab (160) in the working position, depending inwardly from the upper surface of opening (132) of slot (130). FIG. 6b shows end tab (160) flipped outward and upward. End tab (160) may be flipped as shown (or, alternatively, inward and upward) via a tool such as a knife or any other suitable means.

As seen in the figures, particularly FIG. 1, marking (150) comprises a plurality of apertures in band (110), and extends between transverse edges (110a), (110b) of band (110). Marking (150) is shown in the figures as extending essentially entirely between edges (110a), (110b), however, in an alternative embodiment, marking (150) extends only a portion of the way from either edge (110a) or edge (110b), or alternatively, marking (150) extends between edges (110a), (110b), but not all the way to edges (110a), (110b).

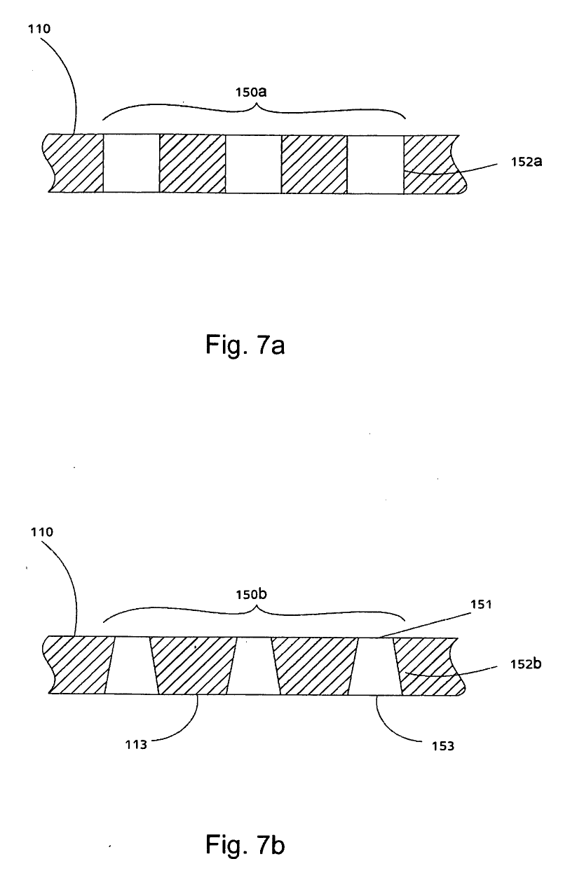

The apertures of marking (150) are preferably perforations to enable band (110) to be cut therealong, as described herein below. FIGS. 7a and 7b, show longitudinal cross-sections of a portion of band (110), wherein the apertures have different forms. FIG. 7a shows one embodiment of apertures of marking (150a) wherein the holes (152a) are through holes, having an essentially cylindrical shape. FIG. 7b shows an alternative embodiment of apertures of marking (150b) wherein the holes (152b) are through holes, having an essentially frusto-conical shape. The narrower opening (151) of holes (152) is planar with outer surface (112) of band (110) and the wider opening (153) is planar with inner surface (113) of band (110). One factor taken into account when determining the shape of the apertures is the ability of the apertures to maintain the bonding material, as described herein below, within the hole in order to improve retention of band (110) around the tooth.

It is understood that alternative shapes and forms of the apertures of the marking on band (110) are included under the scope of the present invention. Moreover, in an alternative aspect, marking (150) comprises an indicative line without apertures, for showing the preferred location at which it is desired to separate the portions of band (110).

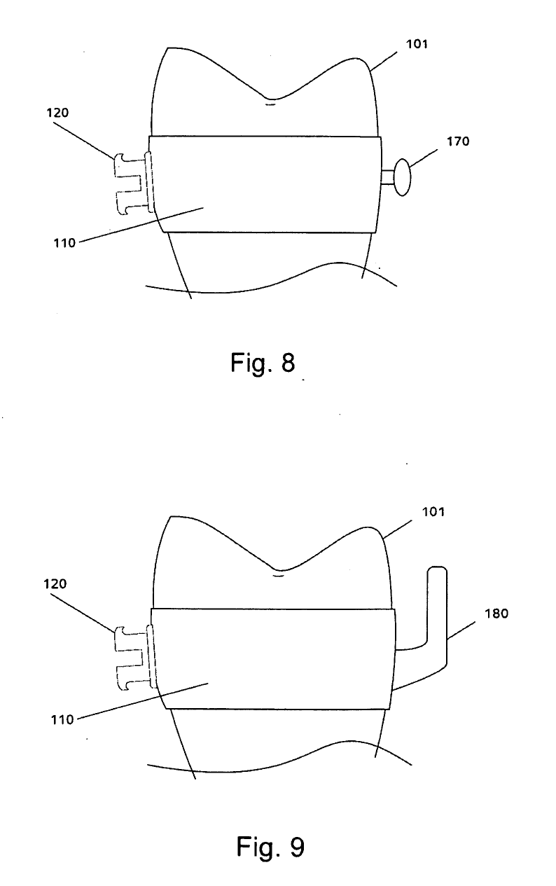

Referring to FIG. 8, when wire holding mechanism (120) is affixed to band (110) on the lingual side of tooth (101), a knob element (170) may be affixed to band (110) on the buccal side of tooth (101) for enabling tooth rotation. Alternatively, with reference to FIG. 9, a vertical hook element (180) may be affixed to band (110) at the buccal side of tooth (101) when wire holding mechanism (120) is situated at the lingual side of tooth (101), for mounting internal rubber bands on hook element (180).

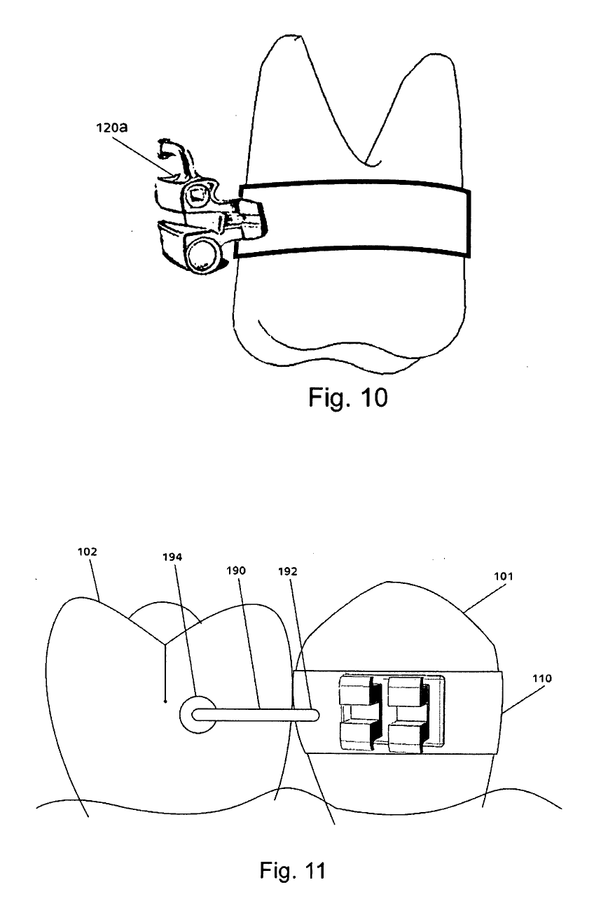

In some instances, the orthodontist may desire to position tubes around the upper molar teeth to connect orthodontal headgear thereto, in which case the wire holding mechanism (120a) is positioned on the buccal side of the tooth, and comprises openings and a form as shown in FIG. 10. Although not shown in the figure, it is understood that a conventional bracket may be located along the band at the lingual side of the tooth.

Referring to FIG. 11, a horizontal hook (190) may be affixed to band (110) at a first end (192) and to the adjacent tooth (102) at a second end (194) for providing anchorage during treatment to prevent mesial movement.

In order to further maintain wire holding mechanism (120) in its desired place on the tooth, a bonding material is preferably utilized to adhere band (110) to the tooth at the location of wire holding mechanism (120) by placing a bonding agent on the inner surface of band (110), behind wire holding mechanism (120). No prior etching is required, although such a procedure may be performed if desired. Depending on the form of the apertures of marking (150), the bonding material may well up within the apertures to further aid in the retention of band (110) around the tooth.

Alternatively, in the embodiment in which wire holding mechanism (120) is positioned such that its back surface is in contact with the tooth (as described herein above), etching bonding may be performed.

Use of conventional braces bands leads to difficulties after the misaligned teeth are set in their desired positions, and the interproximal spaces are reduced, since the positioning of the band around the tooth prevents complete elimination of the interproximal spaces. According to the present invention, as the interproximal spaces are reduced, the orthodontist may remove the portions of the band positioned interproximally by separating the portions of band (110) by a sharp object such as a blade or slicing via a dental drill, thereby leaving the portion of band (110) having wire holding mechanism (120) extending therefrom, affixed to the tooth via the bonding material.

As described herein above, there exist numerous drawbacks associated with mounting a bracket directly on the tooth. Prior art bands that have brackets affixed thereto also have various drawbacks associated therewith, as described herein above as well. The device (100) of the present invention overcomes all of the drawbacks described herein above with regards to prior art brackets and bands.

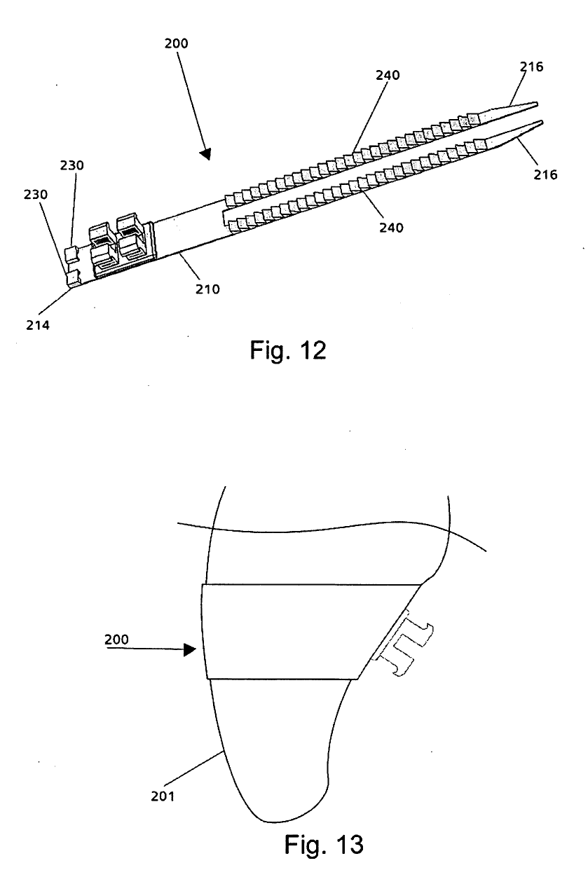

As described herein above, the preferred embodiment of the present invention is for positioning around a molar or premolar tooth. These teeth typically comprise a relatively cylindrical cross-section around which band (110) is wrapped. Referring to FIG. 12, an alternative embodiment (200) of the device of the present invention is shown, comprising all of the same features of the previous embodiment, mutatis mutandis, with the following differences. Stopper elements (240) and second end (216) of band (210) of device (200) are bifurcated into two branches for adjusting band (210) around the molar or premolar tooth that has a shape for which band (110) would be unsuitable. Thus, one branch is inserted through the corresponding one of two slots (230) at first end (214) and is tightened according to the diameter of a first portion of the tooth, and the other branch is inserted through the corresponding other of the two slots (230) at first end (214) and is tightened according to the diameter of the second portion of the tooth.

Alternative embodiments (not shown) of the device of the present invention, comprising all of the same features of one or more of the previous embodiments, mutatis mutandis, may be manufactured for enabling the orthodontist to adjust the band around a tooth in a tightly fit manner. For instance, the band may be manufactured in a slightly bowed (or, rainbow) curvature such that when wrapping around a tooth, the band forms a conical shape. Additionally or alternatively, the stopper elements may be positioned along the band at an angle between the longitudinal sides to enable adjustment of the band around the tooth in a tightly fit manner. Additionally or alternatively, the stopper elements may extend only a portion of the way from the edge of either longitudinal side, or may be located between the edges but not extend all the way to each edge of both longitudinal sides.

In an alternative embodiment, for positioning around a cuspid tooth, as shown in FIG. 13, the band preferably comprises one or more crimps (crease, bending, etc.) in order to accommodate the curvature of the cross-section of the tooth.

Preferably, the inner surface of the device of the present invention has a rough or course surface for adding to the retention around the tooth.

Preferably, a cover (not shown in the figures) is included within the present invention for covering the slot and/or portion of stopper elements remaining on the band for both aesthetic and safety reasons.

In addition to the above advantages, it should be noted that utilizing the device of the present invention reduces the potential danger to crowned teeth as described above. This is because the flexibility of the band of the present invention as well as the ability to adjust the final diameter size, allows the orthodontist to reduce the pressure around the tooth and crown, so as to prevent damage thereto. Moreover the difficulties associated with positioning a bracket directly on the tooth, such as requiring dryness in the mouth, are reduced and in some cases even eliminated. Furthermore, the potential that a bracket will pop off the tooth when pulling the archwire through the brackets or afterward, during eating of hard foods, is substantially reduced due to the retention of the bracket to the band, and not directly to the tooth. In addition, even in cases of severe malocclusions and deep bites, due to the strength of the retention of the bracket, blocking devices are not required to be placed in the mouth to prevent the jaws from performing a complete bite, thereby reducing the discomfort of the patient.

It is understood that the above description of the embodiments of the present invention are for illustrative purposes only, and is not meant to be exhaustive or to limit the invention to the precise form or forms disclosed, as many modifications and variations are possible. Such modifications and variations are intended to be included within the scope of the present invention as defined by the accompanying claims.

1. An orthodontic device comprising an elongated flexible band for wrapping around a tooth, wherein said band comprises an inner surface for contacting said tooth and an outer surface having a wire holding mechanism affixed thereto, wherein said wire holding mechanism is positioned at a predetermined location along said band, and wherein said device further comprises a locking mechanism comprising a slot located at a first end of said band and a series of stopper elements protruding from said outer surface of said band, wherein a second end of said band and at least a portion of said stopper elements are insertable through said slot for tightening said band around said tooth, and wherein said band further comprises a marking for indicating a preferred location for separating the portions of said band comprising said locking mechanism components from the portion of said band comprising said wire holding mechanism, wherein each marking is situated on one of each sides of said wire holding mechanism.

2. An orthodontic device according to claim 1, wherein the marking indicates a portion of the band between opposing transversal edges of said band.

3. An orthodontic device according to claim 1, wherein the marking comprises a plurality of apertures in the band.

4. An orthodontic device according to claim 1, wherein the marking comprises perforations in the band.

5. An orthodontic device according to claim 1, wherein the marking is cuttable by a sharp object such as a blade or dental drill.

6. An orthodontic device according to claim 1, wherein the stopper elements protruding from the outer surface of the band are teeth designed to enable said band to be inserted through the slot, and to prevent said band from sliding out of said slot.

7. An orthodontic device according to claim 6, wherein the teeth comprise a front face for inserting through the slot, and a back face designed to prevent said band from sliding out of said slot.

8. An orthodontic device according to claim 7, wherein the front face comprises any one of a rounded curvature and an inclined curvature with respect to the outer surface of the band.

9. An orthodontic device according to claim 7, wherein the back face comprises any one of a rounded curvature and an orthogonal orientation with respect to the outer surface of the band.

10. An orthodontic device according to claim 1, wherein the wire holding mechanism comprises a conventional orthodontic bracket.

11. An orthodontic device according to claim 1, wherein the wire holding mechanism comprises a tube mounting orthodontic bracket.

12. An orthodontic device according to claim 1, wherein the portion of the band comprising the series of stopper elements is bifurcated into two branches for enabling adjusting said band around the tooth according to the curvature of said tooth.

13. An orthodontic device according to claim 12, wherein the slot comprises two independent openings, each of which for receiving one of each branch.

14. An orthodontic device according to claim 1, wherein the wire holding mechanism is located near the slot such that when the band is wrapped around the tooth, said wire holding mechanism and said slot are situated at the same side of said tooth.

15. An orthodontic device according to claim 1, wherein the wire holding mechanism is positioned distant from the slot such that when said band is wrapped around the tooth, said wire holding mechanism and said slot are situated at opposite sides of said tooth.

16. An orthodontic device according to claim 1, wherein the band comprises an arm extending therefrom at one end, for affixing to an adjacent tooth.

17. An orthodontic device according to claim 1, wherein the band comprises a knob element protruding therefrom, for enabling tooth rotation.

18. An orthodontic device according to claim 1, wherein the band comprises a hook element for mounting rubber bands thereon.

19. An orthodontic device according to claim 1, wherein the device further comprises a cover for enclosing the portion of the elements within the mouth.

20. An orthodontic device according to claim 1, wherein the slot comprises a flap for preventing the band from sliding out of said slot in the direction from which it was inserted.

21. An orthodontic device according to claim 20, wherein the flap is repositionable to allow the band to slide out of the slot in the direction from which it was inserted.

22. An orthodontic device according to claim 1, wherein the inner surface of the band comprises a rough texture for increasing retention around the tooth.
